(19) United States
(12) Patent Application Publication
(10) Pub. No.: US 2010/0066168 A1
(43) Pub. Date: Mar. 18, 2010

(54) POWERING A DIRECT CURRENT AIR CONDITIONER USING SOLAR CELLS

(76) Inventor: Joseph GAMLIEL, Ahuzat Barak (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/212,061

(22) Filed: Sep. 17, 2008

(51) Int. Cl. H02J 9/04

(52) U.S. Cl. 307/23

(57) ABSTRACT

A power emulating module within a powering system for a direct current air conditioner that utilizes solar cells array as a power source. The power emulating module enables to both convert the source signal from the solar cells array into the required voltage levels for the direct current motor of the air conditioner and further generate an alternating current control signal required for the motor control modules. In embodiments, the power emulating module is arranged to be retrofitted into an existing direct current air conditioner exhibiting a rectifying bridge, a motor power module and a motor control module, wherein the air conditioner is operable with an alternating current source. This is achieved by bypassing the rectifying bridge and routing the solar cells array via the power emulating module to the motor power module and further connecting power emulating module to the existing motor control module.

### TECHNICAL FIELD

The present invention relates to the field of direct current air conditioners, and more particularly such air conditioners powered by solar cells arrays.

### BACKGROUND OF THE INVENTION

Prior to setting forth the background of the invention in detail, it may be helpful to set forth definitions of certain terms that will be used hereinafter.

The term “direct current air conditioner” as used herein in this application, is defined as an air conditioner in which the compressor is implemented as an electric direct current motor. An air conditioner, for the purpose of this application is defined as an appliance, system, or mechanism designed to extract heat from an area using a refrigeration cycle. In the refrigeration cycle, a heat pump transfers heat from a lower temperature heat source into a higher temperature heat sink. Heat would naturally flow in the opposite direction. This is the most common type of air conditioning. This cycle takes advantage of the way phase changes work, where latent heat is released at a constant temperature during a liquid/gas phase change, and where a different pressure of a pure substance means that it will condense/boil at a different temperature. The most common refrigeration cycle uses an electric motor to drive a compressor, which is, in the case of a direct current air conditioner, a direct current motor.

The term “direct current to direct current (DC-DC) converter” as used herein in this application, is defined as an electronic device that are arranged to receive a direct current having specific properties in one end and deliver a direct current having other properties. Such electronic devices often contain several sub-circuits with its own voltage level requirement different than that supplied by the battery or an external supply.

The term “solar cell” or “photovoltaic cell” as used herein in this application, is defined as a device that converts solar energy into electricity by the photovoltaic effect. Assemblies of cells are used to make solar modules, which may in turn be linked in photovoltaic arrays.

FIG. 1 shows a schematic high level block diagram illustrating a direct current powering system 10 for a direct current air conditioner that is being powered by an alternating current source according to the prior art. Powering system 10 comprises an alternating current power source 20 connected to a rectifying bridge 30 that in turn is connected to a motor power module 40 and a motor control module 50. Motor power module 40 and motor control module 50 are each connected to direct current motor 60.

In operation, the alternating current from alternating current power source 20 is rectified by rectifying bridge 30 and then delivered to motor power module 40 which is arranged to provide a power signal in order to drive direct current motor 60. Motor control module 50 is arranged to receive the alternating current and provide direct current motor 60 with a control signal in accordance with the power signal. Motor power module 40 and motor control module 50 are each connected to direct current motor 60.

One of the challenges in powering a direct current air conditioner is adjusting current systems operating with alternating current source to operate with a pure direct current source such as solar cells arrays.

### BRIEF SUMMARY

Accordingly, it is a principal object of the present invention to overcome the disadvantages of the prior art. This is provided in the present invention by adding direct current conversion functionality to the powering system while retaining alternate current powering for controlling the direct current motor which is essential direct current powered but alternating current controlled.

In embodiments of the present invention, there is provided a power emulating module within a powering system for a direct current air conditioner that utilizes solar cells array as a power source. Power emulating module enables to both convert the source signal from the solar cells array into the required voltage levels for the direct current motor of the air conditioner and further generate an alternating current control signal required for the motor control modules.

In embodiments, the power emulating module is arranged to be retrofitted into an existing direct current air conditioner exhibiting a rectifying bridge, a motor power module and a motor control module, wherein the air conditioner is operable with an alternating current source. This is achieved by bypassing the rectifying bridge and routing the solar cells array via the power emulating module to the motor power module and further connecting power emulating module to the existing motor control module.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a high level schematic block diagram showing a powering system for a direct current air conditioner having an alternating current power source according to the prior art;

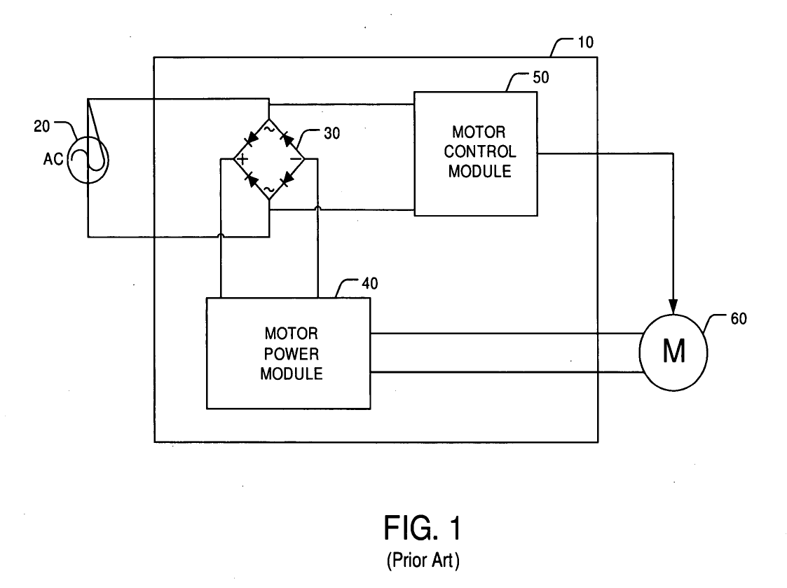

FIG. 2 is high level schematic block diagram showing a powering system for a direct current air conditioner having a solar cells array as a power source according to the present invention; and

FIG. 3 is a high level flow chart showing a method according to some embodiments of the invention.

The drawings together with the description make apparent to those skilled in the art how the invention may be embodied in practice.

### DETAILED DESCRIPTION OF THE INVENTION

Embodiments of the present invention provide a power emulating module within a powering system for a direct current air conditioner that utilizes solar cells array as a power source. Power emulating module enables to both convert the source signal from the solar cells array into the required voltage levels for the direct current motor of the air conditioner and further generate an alternating current control signal required for the motor control modules.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

Although embodiments of the present invention are described hereinafter in relation to solar cells array, other types of DC sources, such as wind, grid etc are operable with the these embodiments.

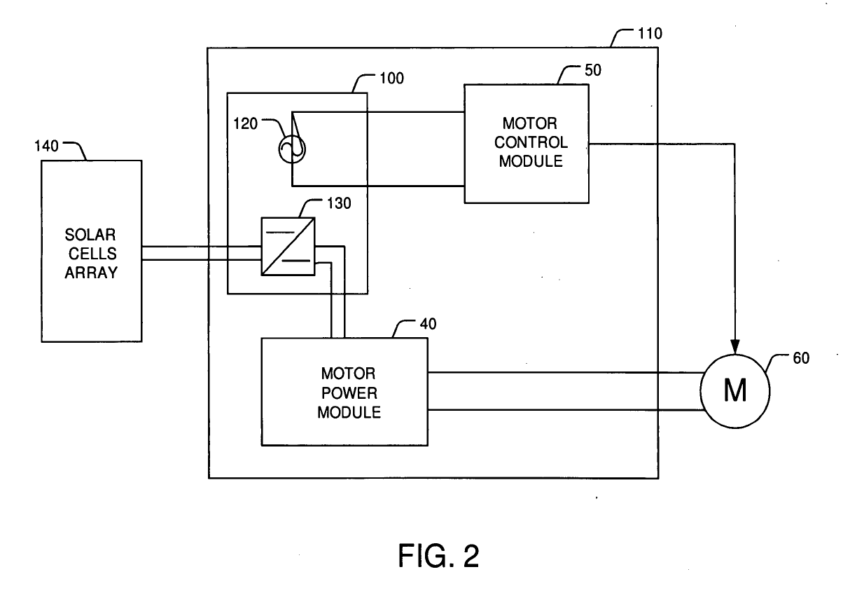

FIG. 2 is a schematic block diagram of a powering system for a direct current air conditioner utilizing solar cells array according to some embodiments of the present invention. Powering system 10 is operatively associated with a solar cells array 140 and comprises a motor power module 40 and a motor control module 50 that are both coupled to a power emulating module 100. Power emulating module 100 comprises a direct current to direct current (DC-DC) converter 120 and a local alternating current source 130. Further, motor power module 40 and motor control module 50 are each connected to direct current motor 60.

In operation, direct current source signal from solar cells array 140 (typically 30V) is converted by DC-DC converter 120 within emulating module 100 into a direct current powering signal exhibiting the required voltage level for direct current motor 60 (typically 300V) and then delivered to motor power module 40 which is arranged to drive the power of direct current motor 60.

Local alternating current source 130 within emulating module 100 is arranged to generate an alternating current signal responsive to user defined air conditioning parameters and direct current powering signal from DC-DC converter 120. Motor control module 50 is arranged to receive the alternating current and provide direct current motor 60 with a corresponding control signal.

According to some embodiments, the power emulating module is arranged to be retrofitted into an existing system for powering a direct current motor in an air conditioner utilizing an alternating current power source and exhibiting a rectifying bridge, a motor power module and a motor control module.

According to some embodiments, retrofitting is achieved by bypassing the rectifying bridge and routing the solar cells array via the power emulating module to the motor power module and connecting the power emulating module to the motor control module.

According to some embodiments, the power emulating module is operable within a system for powering a direct current motor in an air conditioner utilizing both an alternating current power source and solar cells array and further comprising a relay module for enabling operation in one of: solar cells mode, alternate current mode.

According to some embodiments, the DC-DC converter is a flyback converter.

According to some embodiments, the DC-DC converter is arranged to convert a signal exhibiting a voltage level of approximately 30 volts into a signal exhibiting a voltage level of approximately 300V.

According to some embodiments there is provided a system for powering a direct current motor in an air conditioner operatively associated with a solar cells array. The system comprising: a power emulating module exhibiting a direct current to direct current (DC-DC) converter and a local alternating current source; a motor power module; a motor control module, wherein the DC-DC converter is arranged to convert a direct current source signal generated by the solar cells array and deliver a powering signal in a required voltage level to the direct current motor; and wherein the local alternating current is arranged to generate an alternating current signal responsive to user defined air conditioning parameters and direct current powering signal from the DC-DC converter and deliver the alternating current signal to the motor control module.

According to some embodiments the system further comprises a solar cells array and a direct current motor.

According to some embodiments, the power emulating module is arranged to be retrofitted into an existing system for powering a direct current motor in an air conditioner utilizing an alternating current power source and exhibiting a rectifying bridge, a motor power module and a motor control module.

According to some embodiments, the system utilizes both an alternating current power source and solar cells array and further comprising a relay module for enabling operation in one of: solar cells mode, alternate current mode.

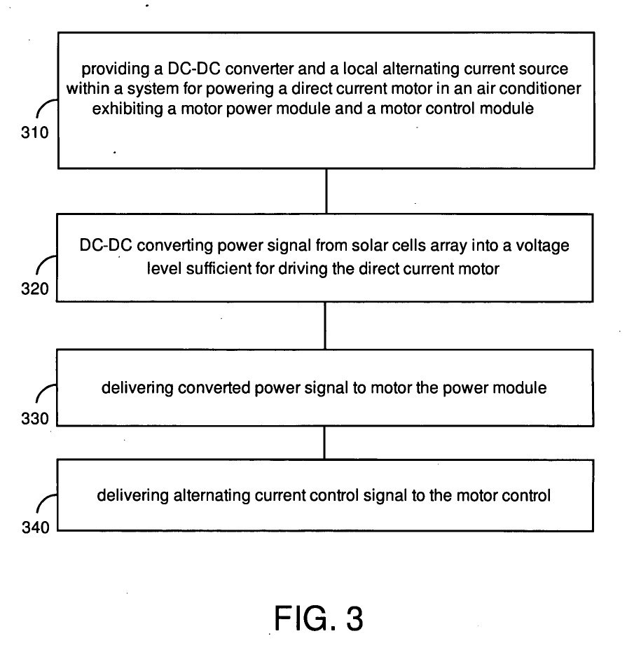

FIG. 3 is a high level flow chart showing a method according to some embodiments of the invention. The disclosed method is a method of powering a direct current motor in an air conditioner, the method comprising: providing a DC-DC converter and a local alternating current source within a system for powering a direct current motor in an air conditioner exhibiting a motor power module and a motor control module 310; DC-DC converting power signal from solar cells array into a voltage level sufficient for driving the direct current motor 320; delivering converted power signal to motor the power module 330; and delivering alternating current control signal to the motor control 340.

According to some embodiments of the invention, the power emulator module or the system can be implemented in digital electronic circuitry, or in computer hardware, firmware, software, or in combinations thereof.

The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, digital signal processors (DSPs) but also general purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices.

The processor and the memory can be supplemented by, or incorporated in, ASlCs (application-specific integrated circuits).

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. In a system for powering a direct current motor in an air conditioner utilizing a solar cells array and exhibiting a motor power module and a motor control module, a power emulating module comprising:
a direct current to direct current (DC-DC) converter; and
a local alternating current source,
wherein the DC-DC converter is arranged to convert a direct current source signal generated by the solar cells array and deliver a powering signal in a predefined voltage level sufficient to power the direct current motor; and
wherein the local alternating current is arranged to generate an alternating current signal responsive to user defined air conditioning parameters and direct current powering signal from the DC-DC converter and deliver the alternating current signal to the motor control module.

2. The power emulating module according to claim 1, wherein the power emulating module is arranged to be retrofitted into an existing system for powering a direct current motor in an air conditioner utilizing an alternating current power source and exhibiting a rectifying bridge, a motor power module and a motor control module.

3. The power emulating module according to claim 2, wherein retrofitting is achieved by bypassing the rectifying bridge and routing the solar cells array via the power emulating module to the motor power module and connecting the power emulating module to the motor control module.

4. The power emulating module according to claim 1, wherein the power emulating module is operable within a system for powering a direct current motor in an air conditioner utilizing both an alternating current power source and solar cells array and further comprising a relay module for enabling operation in one of: solar cells mode, alternate current mode.

5. The power emulating module according to claim 1, wherein the DC-DC converter is a flyback converter.

6. The power emulating module according to claim 1, wherein the DC-DC converter is arranged to convert a signal exhibiting a voltage level of approximately 30 volts into a signal exhibiting a voltage level of approximately 300V.

7. A system for powering a direct current motor in an air conditioner operatively associated with a solar cells array, the system comprising:
a power emulating module exhibiting a direct current to direct current (DC-DC) converter and a local alternating current source;
a motor power module;
a motor control module,
wherein the DC-DC converter is arranged to convert a direct current source signal generated by the solar cells array and deliver a powering signal in a required voltage level to the direct current motor; and
wherein the local alternating current is arranged to generate an alternating current signal responsive to user defined air conditioning parameters and direct current powering signal from the DC-DC converter and deliver the alternating current signal to the motor control module.

8. The system according to claim 7, further comprising a solar cells array

9. The system according to claim 7, further comprising a direct current motor.

10. The system according to claim 7, wherein the power emulating module is arranged to be retrofitted into an existing system for powering a direct current motor in an air conditioner utilizing an alternating current power source and exhibiting a rectifying bridge, a motor power module and a motor control module.

11. The system according to claim 10, wherein retrofitting is achieved by bypassing the rectifying bridge and routing the solar cells array via the power emulating module to the motor power module and connecting the power emulating module to the motor control module.

12. The system according to claim 7, utilizing both an alternating current power source and solar cells array and further comprising a relay module for enabling operation in one of: solar cells mode, alternate current mode.

13. The system according to claim 7, wherein the DC-DC converter is a flyback converter.

14. The system according to claim 7, wherein the DC-DC converter is arranged to convert a signal exhibiting a voltage level of approximately 30 volts into a signal exhibiting a voltage level of approximately 300V.

15. A method of powering a direct current motor in an air conditioner, the method comprising:
providing a DC-DC converter and a local alternating current source within a system for powering a direct current motor in an air conditioner exhibiting a motor power module and a motor control module;
DC-DC converting power signal from solar cells array into a voltage level sufficient for driving the direct current motor;
delivering converted power signal to motor the power module; and
delivering alternating current control signal to the motor control.

16. The method according to claim 15, wherein providing a DC-DC converter and a local alternating current source within a system for powering a direct current motor in an air conditioner is followed by routing solar cells array via the DC-DC converter to the motor power module and routing the local alternating current source to the motor control module.
